(19) United States
(12) Patent Application Publication
(10) Pub. No.: US 2015/0032673 A1
(43) Pub. Date: Jan. 29, 2015

(54) Artist Predictive Success Algorithm

(71) Applicant: Next Big Sound, Inc., New York, NY (US)

(72) Inventors: Victor HU, New York, NY (US); Alex WHITE, New York, NY (US)

(21) Appl. No.: 14/302,200

(22) Filed: Jun. 11, 2014

Related U.S. Application Data
(60) Provisional application No. 61/834,797, filed on Jun. 13, 2013.

(51) Int. Cl. G06N 99/00; H04L 29/06; G06N 5/04

(52) U.S. Cl. CPC G06N 99/005; G06N 5/04; H04L 65/403
USPC 706/12

(57) ABSTRACT

Systems and methods are described for training a predictive model using social media data for artists from a period of time prior to the immediate past year and for using the trained model on social media metrics collected in the immediate prior year for the same set of artists to predict probability of success in a future period of time. The “training set” of artists includes both artists that have experienced success in the past year and artists that have yet to experience any success according to selected criteria. The predictive model predicts the next big musical success in the entertainment marketplace.

### RELATED APPLICATION

This application claims the benefit of U.S. Patent Application No. 61/834,797, filed Jun. 13, 2013.

### TECHNICAL FIELD

The embodiments described herein relate generally to a predictive success algorithm that uses prior social media data of artists to train a predictive model for identifying probability of success for such artists in the subsequent year.

### BACKGROUND

There is a need for systems and methods for training a predictive model and using the trained predictive model to predict the next big musical success in the entertainment marketplace.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF DRAWINGS

FIG. 1 is block diagram of the predictive model success platform, under an embodiment.

FIG. 2 is a block diagram of predictive model data collection, under an embodiment.

FIG. 3 is a flow diagram showing steps of the predictive model approach, under an embodiment.

### DETAILED DESCRIPTION

Embodiments described herein include systems and methods for training a predictive model using social media data for artists from a period of time prior to the immediate past year and for using the trained model on social media metrics collected in the immediate prior year for the same set of artists to predict probability of success in a future period of time. The “training set” of artists includes both artists that have experienced success in the past year and artists that have yet to experience any success according to criteria defined below. The trained predictive model is used to predict the next big musical success in the entertainment marketplace.

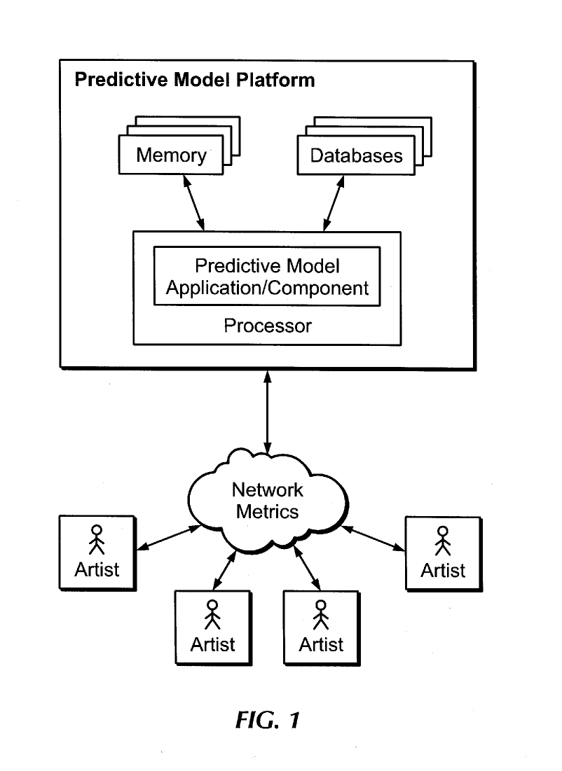

FIG. 1 is a block diagram of a predictive model system. The system comprises a predictive model platform including at least one processor coupled to one or more memory devices or databases. A predictive model component or application running on the processor provides and implements the predictive model described herein.

In the discussion set forth below, the terms predictive model or predictive algorithm are generally used to describe a process of collecting data, transforming data, preparing data for analysis, handling of missing data, model training and application of the trained model. At times, predictive model or predictive algorithm may also refer to an underlying statistical or trained model used to generate success predictions. The context of these terms as used in the discussion below governs their meaning.

The data collection process of a predictive model embodiment builds a comprehensive list of artists through an iterative link spidering process. This approach is based on an assumption that artists follow and are friends with other artists and that social media relationships articulate a community of artists. Iterative link spidering begins with a seed list of artists on a certain network. Under an embodiment, a network may include social media platforms, content sharing platforms and content delivery platforms. Starting from the seed list of artists, top artist friends of seed artists on the same network are identified. Network APIs are then used to obtain corresponding new artist profiles that are added to a comprehensive database of a predictive model. This spidering process iterates with respect to the expanded set of artists on the network in order to pick up as many new artists as possible. As new artists are identified on a network, links to those artists' pages on other networks are also gathered and grouped together to form a more complete artist profile. This iterative link spidering approach is under one embodiment much more accurate than using direct name searches on each network.

The predictive model collects network data or network metrics on artists included in the comprehensive list. As further described below, network metrics may include SoundCloud Plays, SoundCloud Followers, Wikipedia Pageviews, Vevo Video Views, Rdio Plays, Rdio Track Listeners, Facebook Page Likes, Mediabase Feed Radio Spins, Twitter Mentions, Twitter Retweets, Twitter Followers, YouTube Video Views, and YouTube Subscribers. These listed network metrics represent under one embodiment data inputs for the trained/applied predictive model.

An additional predictive model input/indicator may under one embodiment include success of an artist in the most recent week. The predictive model described herein identifies success using a measure of market exposure. Under one embodiment, success criteria are based on sales data. Such embodiment utilizes an artist's appearance on the Billboard 200, a weekly ranking of the 200 highest-selling music albums and EP's in the United States, as the criterion for success. Billboard began the album chart in 1945 with five positions, expanded to 200 positions in 1967, and publishes new charts every Thursday for the prior week. Both digital downloads and physical sales are included in the Billboard 200 tabulation. Any single appearance by an artist on the Billboard 200 within the prior year qualifies the artist as having achieved success during such year.

As indicated above, the Billboard 200 is a ranking of the 200 highest-selling music albums and EPs in the United States, published weekly by Billboard magazine. It is frequently used to convey the popularity of an artist or groups of artists. Often, a recording act will be remembered based on its “number ones,” i.e., albums that outsold all others during at least one week. The chart is based solely on sales (both at retail and digitally) of albums in the United States. The sales tracking week begins on Monday and ends on Sunday. A new chart is published the following Thursday with an issue date of the Saturday of the following week. The Billboard 200 can be helpful to radio stations as an indication of the types of music listeners are interested in hearing. Retailers can also find it useful as a way to determine which recordings should be given the most prominent display in a store. Other outlets, such as airline music services, also employ the Billboard charts to determine their programming.

Success criteria are not limited to appearances on the Billboard 200. Under alternative embodiments, success of an artist may be defined according to various indicators of market exposure. As one example, success criteria may establish the number of concert appearances as main or warm up act as an indicator of success. As another example, number of references to an artist in print/electronic media may provide an indicator of success. Additional embodiments may define success criteria to include Billboard Hot 100 for individual track sales instead of albums, iTunes charts, sell-out tours, gross revenue milestones, etc. These alternative proxies for success of an artist may be used (either alone or in combination) in place of or together with the Billboard 200 criterion. Alternatively, the predictive model may incorporate or migrate to other commercial success rankings as the basis for the predictive model's success criteria.

The predictive model approach of an embodiment collects social media data for artists in a comprehensive data set. Data is collected through a combination of APIs, data feeds, and licensing agreements with third party data providers. The data for each artist in the comprehensive database with data for at least one of the network metrics (i.e. predictive model inputs) listed above is gathered and included in the dataset used to train the predictive model. Accordingly, the artists included in the predictive model may represent a subset of the artists in the comprehensive database.

Using the social media data for the subject artists prior to the past year, a gradient boosted model is trained for classification of artists based on the data. The model is then applied to artists' data for the most recent year to generate an estimate of the likelihood of success for the future year.

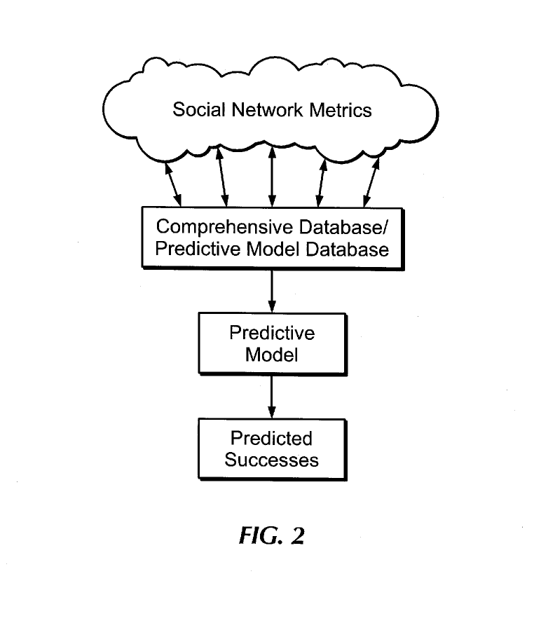

FIG. 2 is a block diagram showing collection of social media metrics for a comprehensive/predictive database of an embodiment for use in the predictive model approach to predicting artist successes as described herein.

Predictive model inputs include social media data for each artist. One embodiment uses inputs comprising both network metrics and transformation of network metrics. The network metrics may include

SoundCloud Plays;

SoundCloud Followers;

Wikipedia Pageviews;

Vevo Video Views;

Rdio Plays;

Rdio Track Listeners;

Facebook Page Likes;

Mediabase Feed Radio Spins;

Twitter Mentions;

Twitter Retweets;

Twitter Followers;

YouTube Video Views; and

YouTube Subscribers.

Regarding the network metrics, SoundCloud is an online audio distribution platform that enables its users to upload, record, promote and share their originally-created sounds. Wikipedia is a collaboratively edited, free access, free content Internet encyclopedia. Vevo is a video hosting service. Rdio is an online music service that offers ad-supported free streaming service and ad-free subscription services.

Mediabase is a music industry service that monitors radio station airplay. Mediabase publishes music charts and data based on the most played songs on terrestrial and satellite radio, and provides in-depth analytical tools for radio and record industry professionals. Mediabase charts and airplay data are used on many popular radio countdown shows and televised music awards programs.

Twitter is an online social networking and microblogging service that enables users to send and read short text messages, called “tweets”. YouTube is a video-sharing website on which users can upload, view and share videos.

Facebook is an online social networking service that has users register before using the site, after which they may create a personal profile, add other users as friends, exchange messages, and receive automatic notifications when they update their profile. Additionally, users may join common-interest user groups, organized by workplace, school or college, or other characteristics, and categorize their friends into lists.

As described herein, each network metric is subject to a set of transformations that are then used as features in the model. Under one embodiment, each metric has the following transformations

New over 7 days—this transformation tracks new plays, followers, etc. acquired over the last 7 days.

New over 30 days—this transformation tracks new plays, followers, etc. acquired over the last 30 days.

New over 90 days—this transformation tracks new plays, followers, etc. acquired over the last 90 days.

Virality over 7 days—this metric measures exponential growth of observed occurrences in a corresponding metric over the last 7 days. The measure is calculated by fitting a second-order polynomial to the observed 7-day data trend and then combining the magnitude of the second order coefficient with the R squared measure of goodness of fit. The metric is determined as max(R̂2,0)*log(max(10000*2nd_order_coefficient))*1000.

Virality over 30 days—this metric measures exponential growth of observed occurrences in a corresponding metric over last 30 days.

Virality over 90 days—this metric measures exponential growth of observed occurrences in a corresponding metric over last 90 days.

Percent (%) Change over 7 days—this metric comprises the percentage change for the last 7 day period compared to the previous 7 day period.

% Change over 30 days—this metric comprises the percentage change for the last 30 day period compared to the previous 30 day period.

% Change over 90 days—this metric comprises the percentage change for the last 90 day period compared to the previous 90 day period.

Total all-time—the total all time metric represents a transformation of each network metric tallying total all time occurrences for each indicator (excluding Wikipedia and Mediabase).

An indicator for whether each artist has achieved success in the most recent time period is also added as an additional predictor. The most recent time period is under one embodiment the last week but may also comprise shorter or longer increments. The success criterion is the same as described above. The predictive model may include the additional indicator of success in the most recent week due to the fact that an artist charting in the most recent week is very likely to repeat a chart appearance in the following week.

The predictive model approach of an embodiment collects network metrics data for the artists prior to the past year. A gradient boosted model is trained for classification of artists based on the data. The model is then applied to artists' data for the most recent year to generate an estimate of the likelihood of success for the future year. The output of the model is the percentage likelihood for each artist reaching the specified success criterion within the next year. This data modeling exercise develops and applies the predictive algorithm over four main stages including initial data preparation, handling of missing data, model training, and predicting values with past charting artist exclusion.

The predictive model approach of an embodiment collects social media data of artists prior to the immediate past year. The “prior data” is collected for inclusion in a training data set. Data for each artist in the comprehensive model database with at least one of the network metrics (i.e. predictive model inputs) listed above is gathered and included in the set. One issue that arises during collection of training data is metric creep—the total number of fans, plays, pageviews, etc. naturally increases over time, so predictions will be inflated from one year to the next. Therefore, initial data preparation includes adjusting collected data to counter the effect of metric creep. In order to counter the metric creep effect, each metric is transformed on the inverse hyperbolic sine scale, and then standardized to have mean 0 and variance 1. The hyperbolic sine transformation is applied to all of the above referenced metrics including the transformed indicators, e.g. virality, percent change, etc.

Another key issue that arises during data collection is the high percentage of missing values due to the fact that artists may not have a presence on every network. Missing data, or missing values, occur when no data value is stored for a variable in the current observation. Missing data are a common occurrence and can have a significant effect on the conclusions that can be drawn from the data. Under one embodiment, testing has shown that the missing at random (MAR) assumption in fact does not hold with respect to the collected network metrics data. Assuming MAR and imputing all missing variables leads under one embodiment to lower predictive accuracy during testing. According to such testing, the absence of a particular network may affect an artist's likelihood of future success. As one approach to the problem, the predictive algorithm accounts for missingness by taking the approach of using surrogate variables as substitutes for the missing predictors.

The model is trained using principles of stochastic gradient boosting. Gradient boosting is a machine learning technique for regression problems, which produces a prediction model in the form of an ensemble of weak prediction models, typically decision trees. It builds the model in a stage-wise fashion like other boosting methods do, and it generalizes them by allowing optimization of an arbitrary differentiable loss function. Gradient boosting method can also be used for classification problems by reducing them to regression with a suitable loss function. See Friedman, J. H. “Greedy Function Approximation: A Gradient Boosting Machine” (February 1999) and Friedman, J. H. “Stochastic Gradient Boosting” (March 1999) for a detailed discussion of gradient boosting and stochastic gradient boosting models.

Under an embodiment of the predictive success algorithm described herein, the model is trained using stochastic gradient boosted decision trees with a Bernoulli loss function. Testing indicates that an interaction depth of two yields the best results under an embodiment, with subsampling fraction set to 0.5, shrinkage set to 0.001 and the number of trees capped at 10,000. An optimal number of trees is estimated using an out-of-bag estimator, which under an embodiment yields better results than a cross-validation method, likely due to issues of over-fitting.

Model design specifications are chosen based on testing of how many 2012 breakout artist successes could be identified using a model trained on 2011 data. A breakout artist comprises an artist that has achieved success (as defined above) over the past year. Breakout artists are used in the model training phase as output verification. Testing accuracy is assessed on how many new successes could be found in the top 100, 200, 300, and 1000 predicted artists using different model designs. Data collection of artists is ongoing and training is updated every month to capture new changes in artist success. Therefore, the predictive model identifies a set of artists every month subject to predictive model analysis. It should be noted that the predictive model of an embodiment described herein is not limited to such design specifications described above and that the design specifications described above do not limit but rather provide an example of a predictive success model using a stochastic gradient boosting approach. It should also be noted that the predictive success model described herein may be implemented using alternative statistical models.

The most recent year's worth of data for each artist is adjusted for metric creep as indicated above and then combined with the model trained on the prior year's data to produce predictions in the form of odds of success for the coming year on a zero to one hundred percent scale; in other words, the fitted model is applied to last years data to generate success predictions. An additional step may exclude from the result set artists who have previously charted where the result set includes predicted log odds of success for each artist in the identified set of subject artists. Previously charted artists will naturally have a much higher likelihood of reaching success again than new artists. Their success forecasts are not the focus of this predictive algorithm and including their results obscures the ability to find newly emerging artists. Past charting artists are excluded after training and prediction. However, data collection continues with respect to such artists; otherwise, model accuracy would decrease if such artists were excluded from the training process. When charting artists are excluded, their data is still collected; but once they are identified as past charting artists, they are simply denoted as a past charting artist in the results interface. Under an embodiment, the interface allows viewing of results for all artists. The previously charted artists are given a score of “Appeared Already”. The interface may provide the user an option to filter artists designated “Already Appearing” from the results. A combination of available historical data is used to generate the list of past charting artists. The historical data may include a past charting appearance. Exclusion of such artists from the final predictions greatly improves the algorithm's ability to satisfy its original purpose—to discover the next big sound.

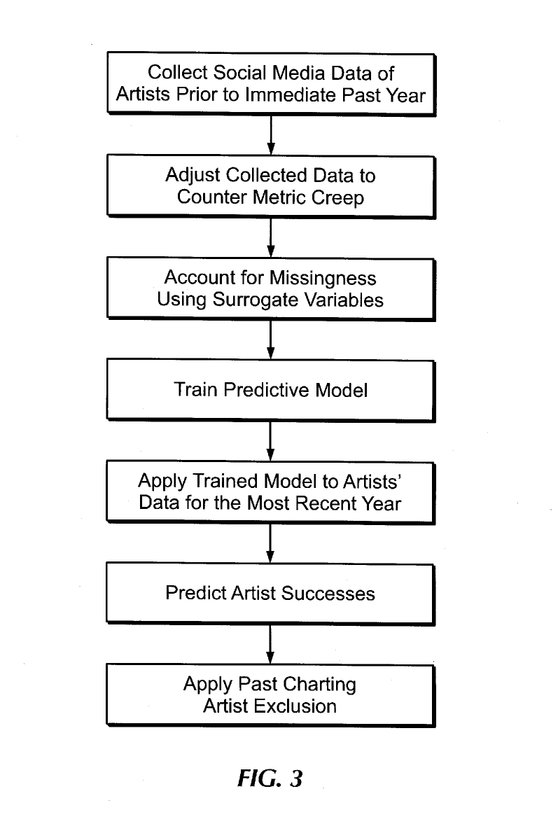

FIG. 3 is a flow diagram showing steps of the predictive model approach from data collection through application of the model, under an embodiment.

Embodiments described herein include a method comprising collecting social media data of a first time period and generating a database that includes the social media data. The social media data corresponds to a plurality of musical artists and comprises network metrics that are subject to a set of transformations. The method comprises generating a trained predictive model by training a predictive model using the social media data of the first time period. The method comprises collecting the social media data of a second time period that is different from the first time period. The method comprises applying the trained predictive model to the social media data of the second time period; and generating a probability of success for each musical artist of the plurality of musical artists, wherein the probability of success corresponds to a future time period and comprises a probability of each musical artist achieving a success criterion.

Embodiments described herein include a method comprising: collecting social media data of a first time period and generating a database that includes the social media data, wherein the social media data corresponds to a plurality of musical artists and comprises network metrics that are subject to a set of transformations; generating a trained predictive model by training a predictive model using the social media data of the first time period; collecting the social media data of a second time period that is different from the first time period; applying the trained predictive model to the social media data of the second time period; and generating a probability of success for each musical artist of the plurality of musical artists, wherein the probability of success corresponds to a future time period and comprises a probability of each musical artist achieving a success criterion.

The first time period of an embodiment comprises a time period prior to an immediate past year as determined according to a current date.

The second time period of an embodiment comprises the immediate past year as determined according to the current date.

The success criterion of an embodiment comprises at least one of an album-based criterion, a track-based criterion, a video-based criterion, an appearance metric-based criterion, and a revenue-based criterion.

The success criterion of an embodiment comprises at least one of appearance on an album ranking chart, appearance on an album download ranking chart, appearance on a track ranking chart, appearance on a track download ranking chart, appearance on a video ranking chart, appearance on a video download ranking chart, having at least one sell-out tour, and achieving a revenue threshold.

The method of an embodiment comprises generating the plurality of musical artists by generating a list of seed artists of a first network, and iteratively expanding the list by identifying artist friends of the first network that correspond to the seed artists, and identifying new musical artists from the artist friends.

The method of an embodiment comprises obtaining artist profiles of the musical artists of the expanded list. The expanded list includes the plurality of musical artists. The obtaining of the artist profiles comprises obtaining artist profiles from a plurality of networks, wherein the plurality of networks include the first network.

The network metrics of an embodiment comprise data of at least one of song plays, video views, followers, subscribers, profile views, page views, posted messages, and posted comments.

The network metrics of an embodiment comprise at least one of SoundCloud plays, SoundCloud followers, Wikipedia pageviews, Vevo video views, Rdio plays, Rdio track listeners, Facebook page likes, Mediabase feed radio spins, Twitter mentions, Twitter retweets, Twitter followers, YouTube video views, and YouTube subscribers.

Each network metric of an embodiment is subject to a set of transformations.

The set of transformations of an embodiment comprises at least one of a new social media data metric, growth of a corresponding social media data metric, change of a corresponding social media data metric, and a total metric representing a total of a set of social media data metrics.

The new social media data metric of an embodiment comprises at least one of New over 7 days, New over 30 days, and New over 90 days.

The growth of the corresponding social media data metric of an embodiment comprises exponential growth of observed occurrences in the corresponding social media metric.

The growth of the corresponding social media data metric of an embodiment comprises at least one of Virality over 7 days, Virality over 30 days, and Virality over 90 days.

The change of the corresponding social media data metric of an embodiment comprises at least one of Percent change over 7 days, Percent change over 30 days, and Percent change over 90 days.

The total metric representing the total of the set of social media data metrics of an embodiment comprises a transformation of each network metric tallying total all time occurrences for each indicator.

The network metrics of an embodiment include success of an artist for a time period.

The method of an embodiment comprises identifying the success using a measure of market exposure, wherein the measure of market exposure comprises at least one of album sales data, track sales data, album download data, track download data, ranking data of chart services, at least one of number of concert appearances and type of concert appearances, at least one of number and type of media references to an artist, and revenue data.

The method of an embodiment comprises adjusting the collected social media data of the first time period to counter metric creep, wherein the adjusting comprises transforming and then standardizing each metric.

The transforming of an embodiment comprises transforming each metric on an inverse hyperbolic sine scale, wherein the standardizing comprises standardizing each metric to have a mean equal to zero and a variance equal to one.

The method of an embodiment comprises accounting for missing social media data from the collected social media data of the first time period.

The accounting for the missing social media data of an embodiment comprises using surrogate variables as substitutes for missing predictors of the social media data.

The predictive model of an embodiment comprises a gradient boosted model.

The training of the predictive model of an embodiment comprises training the predictive model using stochastic gradient boosted decision trees with a Bernoulli loss function.

The method of an embodiment comprises adjusting the collected social media data of the second time period to counter metric creep.

The method of an embodiment comprises removing any musical artist having previously met the success criterion, wherein the removing follows the generating of the probability of success.

Under an embodiment, the predictive model described herein may include one or more applications running on one or more processors and may use one or more databases to store collected data. Embodiments of the predictive model running on one or more processors may interface with third party data providers using network couplings. Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The predictive model can be a component of a single system, multiple systems, and/or geographically separate systems. The predictive model can also be a subcomponent or subsystem of a single system, multiple systems, and/or geographically separate systems. The predictive model can be coupled to one or more other components (not shown) of a host system or a system coupled to the host system.

One or more components of the predictive model and/or a corresponding interface, system or application to which the predictive model is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the predictive model can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANS), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the predictive model and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the predictive model and corresponding systems and methods include: microcontrollers with memory (such as electronically erasable programmable read only memory (EEPROM)), embedded microprocessors, firmware, software, etc. Furthermore, aspects of the predictive model and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the predictive model and corresponding systems and methods is not intended to be exhaustive or to limit the systems and methods to the precise forms disclosed. While specific embodiments of, and examples for, the predictive model and corresponding systems and methods are described herein for illustrative purposes, various equivalent modifications are possible within the scope of the systems and methods, as those skilled in the relevant art will recognize. The teachings of the predictive model and corresponding systems and methods provided herein can be applied to other systems and methods, not only for the systems and methods described above.

The elements and acts of the various embodiments described above can be combined to provide further embodiments. These and other changes can be made to the predictive model and corresponding systems and methods in light of the above detailed description.

What is claimed is:

1. A method comprising:
collecting social media data of a first time period and generating a database that includes the social media data, wherein the social media data corresponds to a plurality of musical artists and comprises network metrics that are subject to a set of transformations;
generating a trained predictive model by training a predictive model using the social media data of the first time period;
collecting the social media data of a second time period that is different from the first time period;
applying the trained predictive model to the social media data of the second time period; and
generating a probability of success for each musical artist of the plurality of musical artists, wherein the probability of success corresponds to a future time period and comprises a probability of each musical artist achieving a success criterion.

2. The method of claim 1, wherein the first time period comprises a time period prior to an immediate past year as determined according to a current date.

3. The method of claim 2, wherein the second time period comprises the immediate past year as determined according to the current date.

4. The method of claim 1, wherein the success criterion comprises at least one of an album-based criterion, a track-based criterion, a video-based criterion, an appearance metric-based criterion, and a revenue-based criterion.

5. The method of claim 4, wherein the success criterion comprises at least one of appearance on an album ranking chart, appearance on an album download ranking chart, appearance on a track ranking chart, appearance on a track download ranking chart, appearance on a video ranking chart, appearance on a video download ranking chart, having at least one sell-out tour, and achieving a revenue threshold.

6. The method of claim 1, comprising generating the plurality of musical artists by:
generating a list of seed artists of a first network; and
iteratively expanding the list by identifying artist friends of the first network that correspond to the seed artists, and identifying new musical artists from the artist friends.

7. The method of claim 6, comprising obtaining artist profiles of the musical artists of the expanded list, wherein the expanded list includes the plurality of musical artists, wherein the obtaining of the artist profiles comprises obtaining artist profiles from a plurality of networks, wherein the plurality of networks include the first network.

8. The method of claim 1, wherein the network metrics comprise data of at least one of song plays, video views, followers, subscribers, profile views, page views, posted messages, and posted comments.

9. The method of claim 8, wherein the network metrics comprise at least one of SoundCloud plays, SoundCloud followers, Wikipedia pageviews, Vevo video views, Rdio plays, Rdio track listeners, Facebook page likes, Mediabase feed radio spins, Twitter mentions, Twitter retweets, Twitter followers, YouTube video views, and YouTube subscribers.

10. The method of claim 8, wherein each network metric is subject to a set of transformations.

11. The method of claim 10, wherein the set of transformations comprises at least one of a new social media data metric, growth of a corresponding social media data metric, change of a corresponding social media data metric, and a total metric representing a total of a set of social media data metrics.

12. The method of claim 11, wherein the new social media data metric comprises at least one of New over 7 days, New over 30 days, and New over 90 days.

13. The method of claim 11, wherein the growth of the corresponding social media data metric comprises exponential growth of observed occurrences in the corresponding social media metric.

14. The method of claim 13, wherein the growth of the corresponding social media data metric comprises at least one of Virality over 7 days, Virality over 30 days, and Virality over 90 days.

15. The method of claim 11, wherein the change of the corresponding social media data metric comprises at least one of Percent change over 7 days, Percent change over 30 days, and Percent change over 90 days.

16. The method of claim 11, wherein the total metric representing the total of the set of social media data metrics comprises a transformation of each network metric tallying total all time occurrences for each indicator.

17. The method of claim 8, wherein the network metrics include success of an artist for a time period.

18. The method of claim 17, comprising identifying the success using a measure of market exposure, wherein the measure of market exposure comprises at least one of album sales data, track sales data, album download data, track download data, ranking data of chart services, at least one of number of concert appearances and type of concert appearances, at least one of number and type of media references to an artist, and revenue data.

19. The method of claim 1, comprising adjusting the collected social media data of the first time period to counter metric creep, wherein the adjusting comprises transforming and then standardizing each metric.

20. The method of claim 19, wherein the transforming comprises transforming each metric on an inverse hyperbolic sine scale, wherein the standardizing comprises standardizing each metric to have a mean equal to zero and a variance equal to one.

21. The method of claim 1, comprising accounting for missing social media data from the collected social media data of the first time period.

22. The method of claim 21, wherein the accounting for the missing social media data comprises using surrogate variables as substitutes for missing predictors of the social media data.

23. The method of claim 1, wherein the predictive model comprises a gradient boosted model.

24. The method of claim 23, wherein the training of the predictive model comprises training the predictive model using stochastic gradient boosted decision trees with a Bernoulli loss function.

25. The method of claim 1, comprising adjusting the collected social media data of the second time period to counter metric creep.

26. The method of claim 1, comprising removing any musical artist having previously met the success criterion, wherein the removing follows the generating of the probability of success.
